(19) United States
(12) Patent Application Publication
(10) Pub. No.: US 2019/0246802 A1
(43) Pub. Date: Aug. 15, 2019

(54) MESH CRIB

(71) Applicant: BreathableBaby, LLC, Minnetonka, MN (US)

(72) Inventors: Rachel Dacks, Savannah, GA (US); Ian Schaffer, Minnetonka, MN (US); Darrell Vincent, Bristol, RI (US); Mark Pater, Milton, MA (US)

(21) Appl. No.: 16/130,548

(22) Filed: Sep. 13, 2018

Related U.S. Application Data
(60) Provisional application No. 62/557,867, filed on Sep. 13, 2017.

(51) Int. Cl. A47C 21/04; A47D 7/00; A47D 9/00; A47D 15/00; B60B 33/00; A47C 21/08

(52) U.S. Cl. CPC A47C 21/046; A47D 7/00; A47C 21/08; A47D 15/005; B60B 33/0021; A47D 9/00

(57) ABSTRACT

In general a crib includes a first and second side that each have a first perimeter support having a bottom support portion, a first breathable material retained by the perimeter support, and a lateral support member that further supports the breathable material in a position within the perimeter support and attached to the perimeter support. The crib also includes third and fourth sides, wherein the first, second, third and fourth sides define an interior. The crib further includes a mattress support platform positioned in the interior and movable between a first position proximate the lateral support member and a second, lower position proximate the bottom portion of the perimeter support. The breathable material has an air permeability of between 385 CFM to 1530 CFM and a light permeability of between 47 and 99%. In another example a crib includes first and second sides and third and fourth sides that each include a top support fixedly attached to the first and second sides and a bottom support movably attached to the first and second sides, a first breathable material retained by the top support and the bottom support and the breathable material forming a sling for retention of a mattress support platform. The mattress support platform is movable to various positions by moving the bottom support member and wherein the sling also moves such that the breathable material moves up and down to enclose the space above the mattress support platform.

### CROSS-REFERENCE TO RELATED APPLICATIONS

This application claims the benefit of U.S. Provisional Patent Application No. 62/557,867, filed Sep. 13, 2017. The disclosure of which is incorporated by reference herein.

### TECHNICAL FIELD

The present invention relates to cribs and other usable objects (e.g., child or infant objects). More particularly, the present invention pertains to a safer crib design that includes breathable sides, for example, that protect infants or young children from harm, such as, getting limbs extended and caught between crib slats. In addition, such can allow air to flow into, out of or around the interior of the crib.

### BACKGROUND

Conventional baby cribs typically include side rails that are made up of top and bottom horizontal bars interconnected by a series of spaced supports (e.g., vertical slats). Frequently, babies and toddlers, while sleeping or playing in their cribs, intentionally or accidentally extend their limbs out of the crib between the slats and have difficulty drawing them back into the crib. If this occurs when the child is sleeping, the extended limbs will remain uncovered and become cold, and the child will be ultimately awakened or harmed. Many cribs also have headboards and footboards (i.e., end boards) that are also made with spaced-apart supports and the baby may also extend its arms or legs out of the crib between these slats.

Although various types of apparatus have been used to prevent such problematic situations (e.g., extension of limbs outside of the crib through the spaced-apart supports), many of such apparatus exhibit their own problems. For example, as described herein, ventilation may be problematic (e.g., such as that leading up to and resulting in suffocation). For example, crib bumpers are widely used in cribs for protecting a child from injury caused by bodily impact of the child against the sides of the crib that define the interior boundary of the crib. However, in many cases, such bumpers do not allow for adequate ventilation, or air flow, within the crib and also obstruct viewing of the child.

Infants usually breathe through their nasal passages. However, during crying or in the event their nasal passages are blocked, infants may breathe through their oral cavities. Mechanical resistance suffocation takes places when respiration is interrupted if these passages are both blocked externally by an object. When respiration is interrupted, CO₂ levels in the blood rise. The body's response to this elevation in CO₂ levels is to attempt more rigorous respiration. If the agent of suffocation is not removed, the incident may be fatal after two or three minutes. Further, the accumulation of CO₂ or other dangerous gases inside the crib or around the infant may be a possible cause of sudden infant death syndrome (SIDS). Existing crib apparatus, such as crib bumpers, tend to trap dangerous gases inside the crib. Further, such apparatus may block the passages of infants under certain circumstances. Therefore, improvements are desirable.

Various types of other crib apparatus have been described and attempt to reduce one or more of the above problems. For example, such apparatus are described in U.S. Pat. No. 5,881,408 to Bashista et al., entitled “Mesh Crib Liner,” issued 16 Mar. 1999; and U.S. Pat. No. 6,178,573 to Wagner et al., entitled “Ventilation Upgrade Kit for a Crib Bumper and Method of Using It.”

### SUMMARY OF THE INVENTION

The present invention, as described herein, addresses the problems described above and other problems of prior art systems and methods that will become apparent to one skilled in the art from the description below. In general a crib includes a first and second side that each have a first perimeter support having a bottom support portion, a first breathable material retained by the perimeter support, and a lateral support member that further supports the breathable material in a position within the perimeter support and attached to the perimeter support. The crib also includes third and fourth sides, wherein the first, second, third and fourth sides define an interior. The crib further includes a mattress support platform positioned in the interior and movable between a first position proximate the lateral support member and a second, lower position proximate the bottom portion of the perimeter support. The breathable material has an air permeability of between 385 CFM to 1530 CFM and a light permeability of between 47 and 99%. In another example a crib includes first and second sides and third and fourth sides that each include a top support fixedly attached to the first and second sides and a bottom support movably attached to the first and second sides, a first breathable material retained by the top support and the bottom support and the breathable material forming a sling for retention of a mattress support platform. The mattress support platform is movable to various positions by moving the bottom support member and wherein the sling also moves such that the breathable material moves up and down to enclose the space above the mattress support platform.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 shows a perspective view of one embodiment of a crib, according to one example embodiment of the present invention.

FIG. 2 shows another perspective view of the crib of FIG. 1 with the mattress support illustrated in a lower position, according to an example embodiment of the present invention.

FIG. 3 shows another perspective view of the crib of FIG. 1 with the mattress support illustrated in an upper position, according to an example embodiment of the present invention.

FIG. 4 shows a front/back view of the crib of FIG. 1, according to an example embodiment of the present invention.

FIG. 5 shows an end view of the crib of FIG. 1, according to an example embodiment of the present invention.

FIG. 6 shows another end view of the crib of FIG. 1, according to an example embodiment of the present invention.

FIG. 7 is a top view of the crib of FIG. 1, according to an example embodiment of the present invention.

FIG. 8 is a perspective view of an embodiment of a breathable crib with the mattress support and mattress in a raised position, according to one example embodiment of the present invention.

FIG. 9 is a perspective view of the crib of FIG. 8, according to an example embodiment of the present invention.

FIG. 10 is a front perspective view of the crib of FIG. 8, according to an example embodiment of the present invention.

FIG. 11 is another perspective view of the crib of FIG. 8 with the mattress support and mattress in a lowered position, according to one example embodiment of the present invention.

FIG. 12 is another perspective view of the crib of FIG. 8 with the mattress support and mattress in a raised position, according to one example embodiment of the present invention.

FIG. 13 is a second side view of the crib of FIG. 9, according to one example embodiment of the present invention.

FIG. 14 is a top view of the crib of FIG. 9, according to one example embodiment of the present invention.

FIG. 15 shows a perspective view of a second embodiment of a crib, according to example embodiment of the present invention.

FIG. 16 shows another view of the crib of FIG. 15 with the mattress support in a first, raised position, according to an example embodiment of the present invention.

FIG. 17 shows another view of the crib of FIG. 15 with the mattress support in a second position, according to an example embodiment of the present invention.

FIG. 18 shows another view of the crib of FIG. 15 with the mattress support in a third, lowered position, according to an example embodiment of the present invention.

FIG. 19 shows another view of the crib of FIG. 15, according to an example embodiment of the present invention.

FIG. 20 is an illustration a top support member of the crib of FIG. 15, according to an example embodiment of the present invention.

FIG. 21 is an illustration of a mesh gap of the crib of FIG. 15, according to an example embodiment of the present invention.

FIG. 22 is an illustration of a roller storage feature of the crib of FIG. 15, according to an example embodiment of the present invention.

FIG. 23 is an exploded view of the crib of FIG. 15 and the moving mesh sling design, according to an example embodiment of the present invention.

### DETAILED DESCRIPTION OF THE EMBODIMENTS

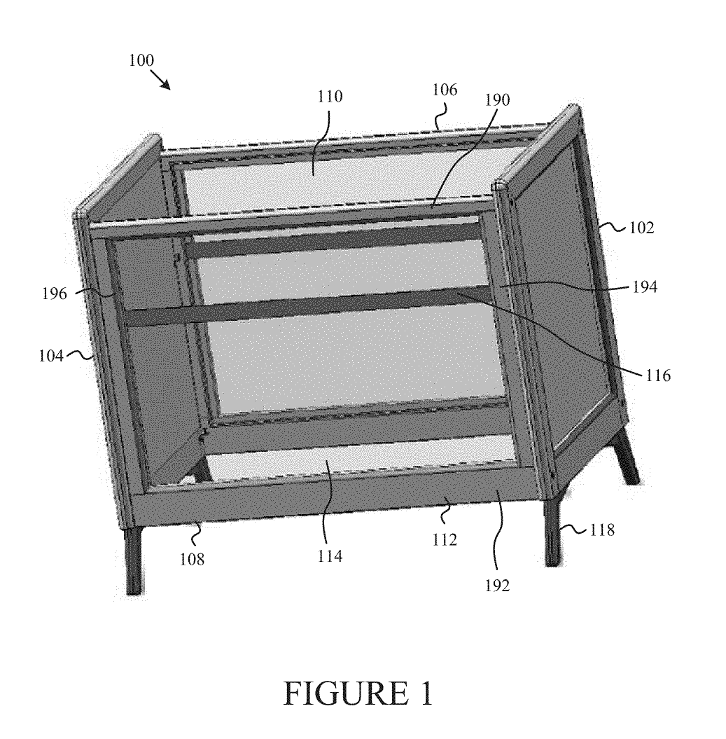

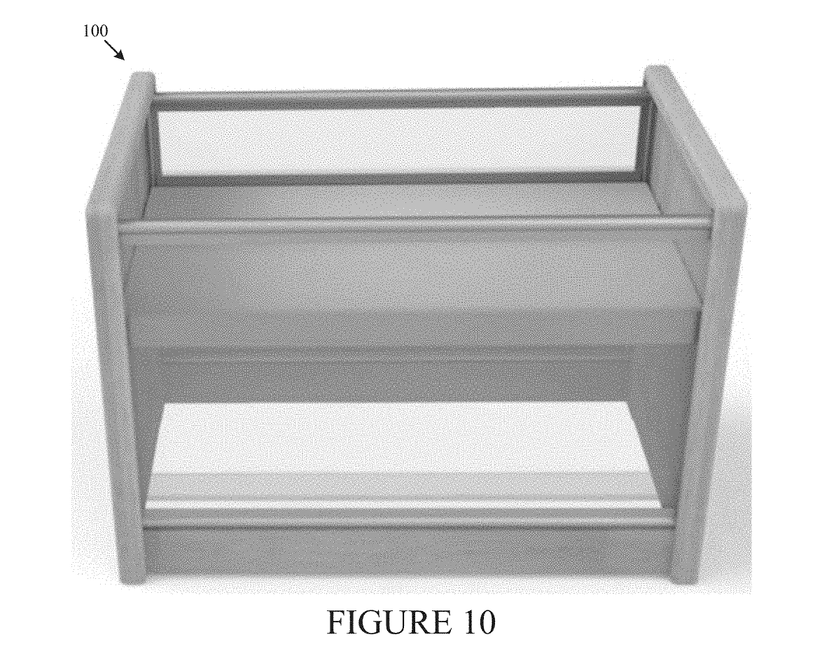

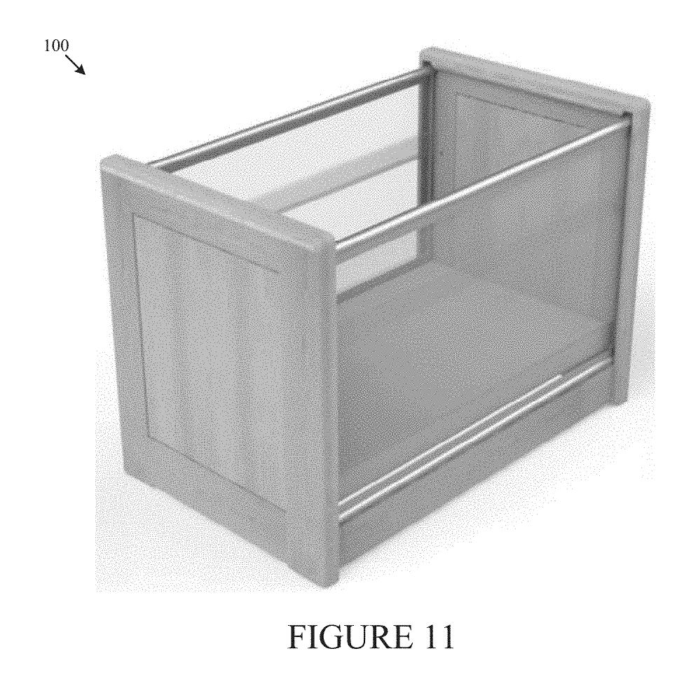

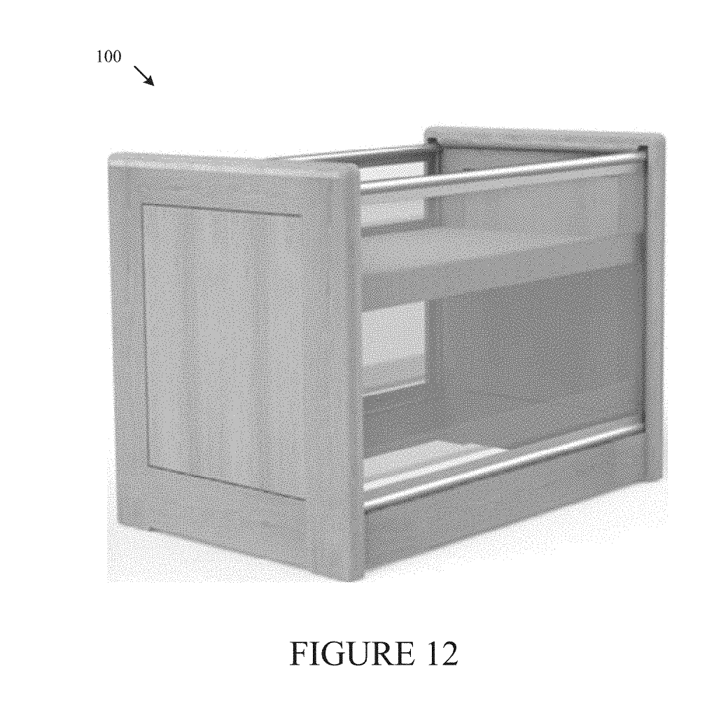

Various embodiments of breathable cribs shall be described with reference to FIGS. 1-23 and the below description. The particular features of the disclosed embodiments should not be limited to just those illustrated configurations. Instead, the various features disclosed within this disclosure may be combined to create exponentially more embodiments not explicitly illustrated within this disclosure. For example, the various fastener apparatus and configurations for attaching the components to a crib disclosed within may be combined in far more configurations than illustrated within the confines of this disclosure. Further, some exemplary embodiments are illustrated as one panel embodiments while other exemplary embodiments are illustrated as two panel embodiments. It should be understood that the features of such illustrated one panel embodiments and illustrated two panel embodiments (e.g., size, shape, fastener arrangement, method of attaching to crib, etc.) may be interchanged and/or combined to form exponentially more embodiments not explicitly illustrated within this disclosure. As such, the claims should not be limited only to such exemplary illustrated embodiments. Additionally, breathable or airflow material not only includes mesh material and padded mesh material, but may also include alternate material(s) that have similar airflow and/or padding properties (e.g., the weave found in cotton sweaters, such as a corded cotton sweater, may be sufficiently padded and breathable).

In general, the present invention is related to a crib design having at least two breathable sides and having a mattress support movable between at least two positions within the crib interior. In general, the American Academy of Pediatrics (“AAP”) now recommends that infants sleep in the parents' room, close to the parents' bed, but on a separate surface designed for infants, ideally for the first year of life, but at least for the first 6 months. Currently, 3,500 infants die annually in the United States from sleep-related deaths, including sudden infant death syndrome (SIDS). The AAP states that sharing a room could cut babies' chance of dying in their sleep by up to 50 percent. The present invention provides a single solution for the first full year room sharing that makes it easier and thus more likely that the infant will sleep in the parents' room. The present invention is different from existing solutions. The present invention is stronger and has breathable sides that protect the infant's limbs from entrapment and defines a safe sleep environment.

Referring to FIG. 1, a crib 100 is generally shown. The crib includes a first side 102, a second side 104, a third side 106 and a fourth side 108. Preferably, the third side 106 and fourth side 108 are wider than the first side 102 and second side 104, such that the four sides 102, 104, 106, 108 define a generally rectangular interior space 110. As illustrated in FIG. 1, the first side 102 and second side 104 are of solid construction for aesthetic reasons, structural support and to prevent entrapment of the infants' limbs. Of course, one of ordinary skill in the art would recognize that alternative designs are also possible.

Preferably, the fourth side 108 includes a perimeter structural support system 112 that surrounds and supports a breathable material 114. The perimeter structural support system having a top portion 190, a bottom portion 192 and first and second side portions 194, 196. The breathable material 114 can be any material that allows air to flow through it, including a mesh like material. The breathable material 114 also allows the crib sides to be see through to see the infant inside. Preferably, the breathable material has an air permeability of between 300 CFM to 1600 CFM and a light permeability of between 40 and 99%.

The fourth side 108 also includes a lateral support member 116. The lateral support member 116 helps retain the breathable material 114 from bowing out if the infant comes in contact with it. The lateral support member 116 can be placed either inside of the crib 100 or preferably outside of the crib 100. Likewise, the third side 106 includes similar construction to that of the fourth side 108.

The crib 100 further includes legs 118 that support the crib 100. As shown in FIG. 1, the legs 118 are angled toward the outsides of the crib to create additional lateral stability for the crib 100. One of ordinary skill in the art would also recognize that other legs designs are possible. Furthermore, the legs 118 could include casters, rollers, felt pads or other devices to enable the crib to be more easily moved about.

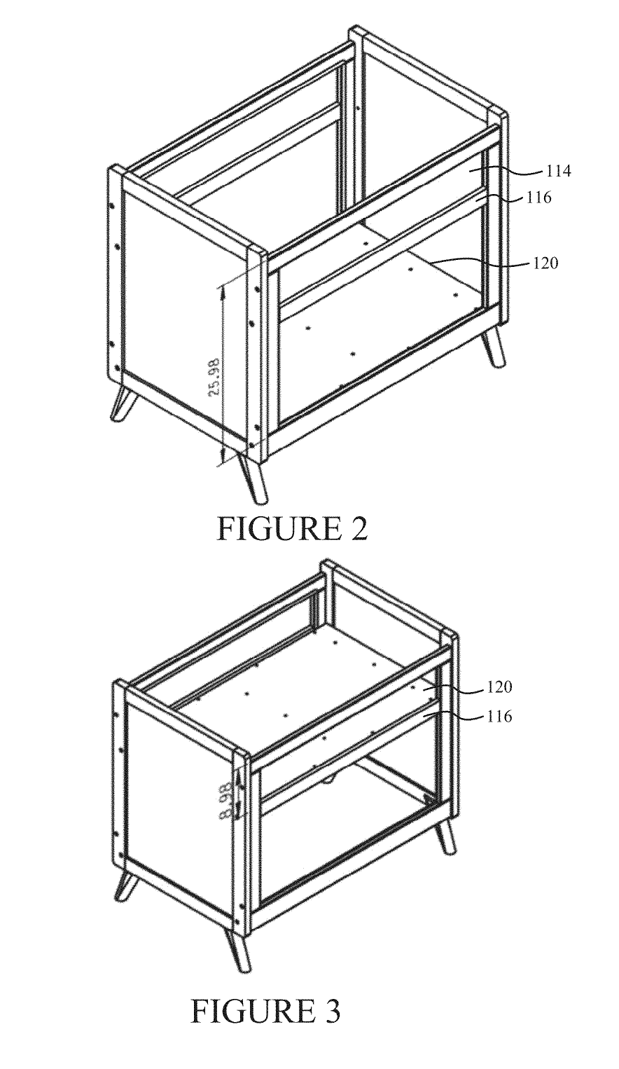

FIG. 2 illustrates the crib 100 with the lateral support member 116 positions outside of the breathable material 114. The crib 100 further includes a mattress platform 120. In FIG. 2, the mattress platform 120 is positioned in the “mini crib” position, which is lower in the crib 100 for when the infant grows to help prevent the infant from climbing or falling out of the crib 100. In this lower position, the mattress platform 120 is proximate the bottom portion 192 of the perimeter support 112. The mattress platform 120 is secured to at least two of the four sides 102, 104, 106, 108 of the crib 100 using any suitable means such as screws, pins, nails or other fastening devices. The mattress platform 120 is movable to at least one other position as shown in FIG. 3 and retained in this position by any suitable means. This raised position is similar to the depth of a bassinet for use when the infant is newborn and up and until the infant begins to push up on hands and knees. This position makes it easier for the parents to reach the infant without bending over more than necessary and to align the infants sleep position with the parents' sleep position for better visual monitoring and foster emotional connection. In this position, the mattress platform 120 is approximately at the same height of the lateral support member 116. The lateral support member 116 prevents the breathable material 114 from bowing and allowing the infant to fall through.

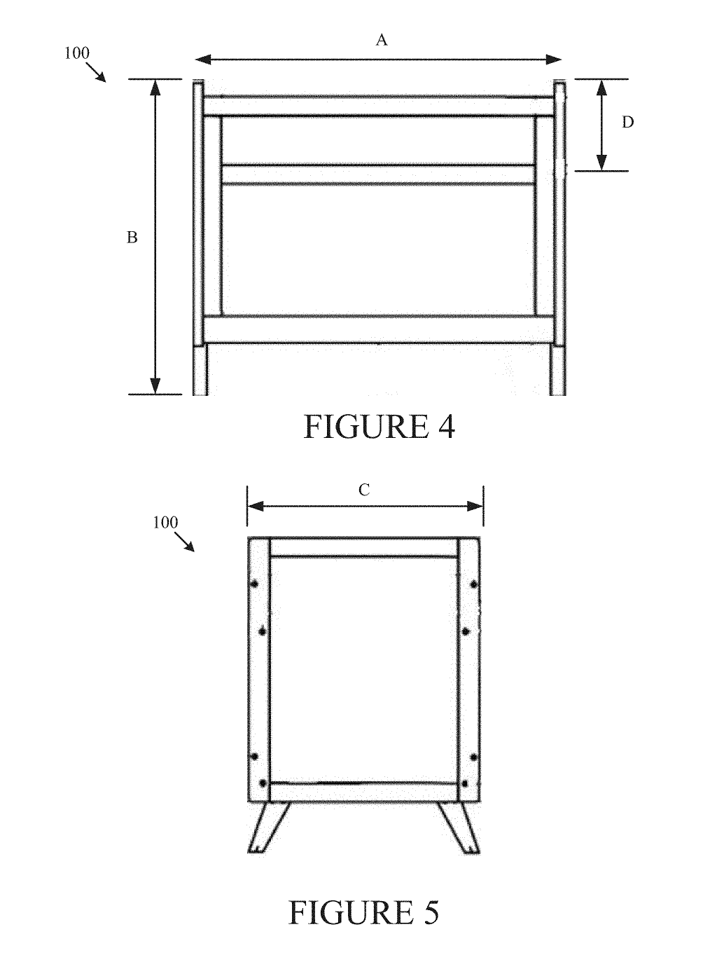

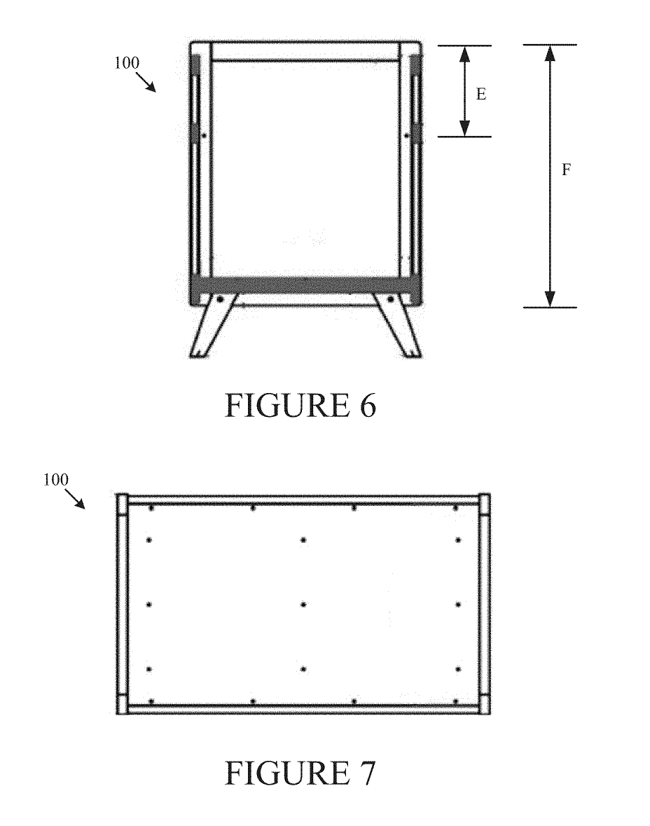

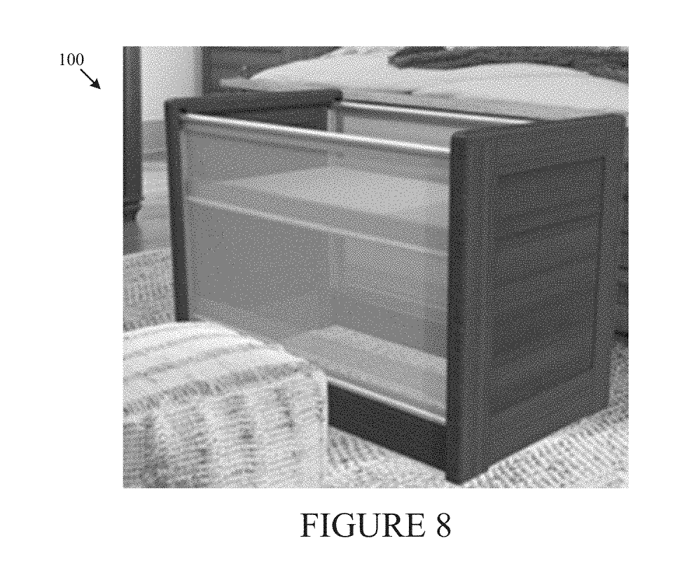

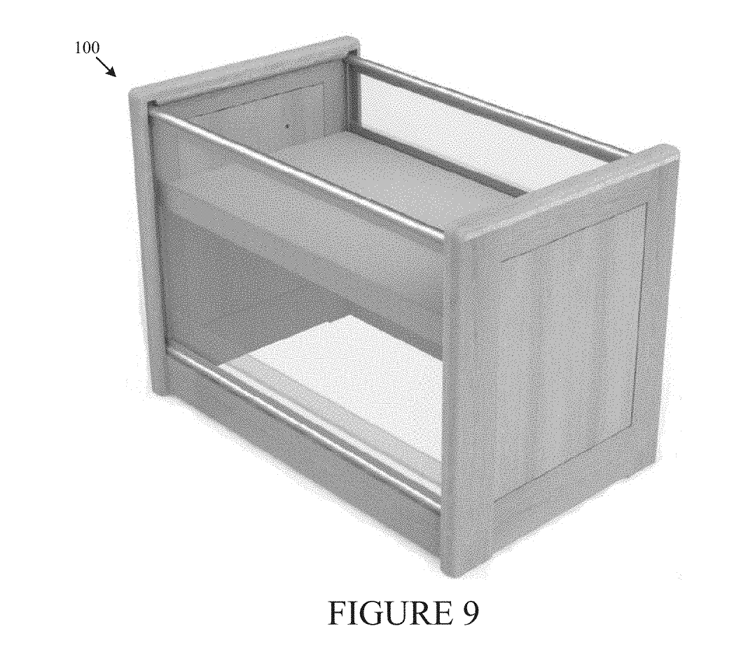

FIG. 4 is a front view of the crib, which is similar to the back view. FIG. 5 is a first end view of the crib 100, and FIG. 6 is the other end view of the crib 100. FIG. 7 is a top view of the crib 100. Preferably, the crib 100 has a length A, a height B, and a width C. Preferably, the length A is approximately between 38 and 42″, the height B is approximately between 30 and 36″ and the width C is approximately between 24 and 26″. Preferably the lateral support member 116 is positioned a distance D from the top of the crib that is approximately 9″ below the top of the perimeter support 112. Also the mattress platform 120 is movable between a first distance E and a second distance F from the top of the crib. Preferably the first distance E is approximately between 8 and 10″, and the second distance F is between 24 and 28″.

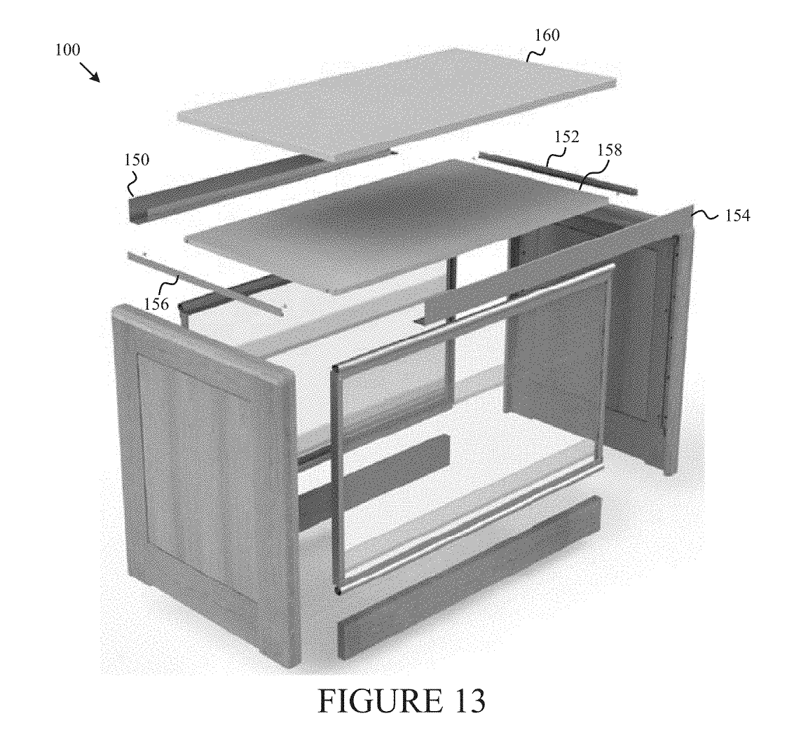

FIG. 8 is a perspective finished photo view of the crib 100. And FIG. 9-14 are other views of the finished crib 100. Referring to FIG. 13, the crib 100 is illustrated in an exploded view showing the different parts of the crib 100, including the mattress platform's 120 components, including first, second, third and fourth frame elements 150, 152, 154, 156 along with a mattress support 158 retained by the frame elements 150, 152, 154, 156. A mattress 160 sits on top of the mattress support 158.

As used herein, the term mattress may include any structure disposed within crib 100 and upon which objects and/or human beings may be placed. In other words, mattress refers to any structure and not just a soft sleeping apparatus. For example, the crib could be configured into a playpen-type structure with a solid hard and/or flat bottom that is, for example, lowered very close to the floor. As such, and as used herein, a crib can be equated to and encompasses the various structures similar to a crib, such as those for containing a small child (e.g., playpens, portable cribs, basinets, convertible cribs, round cribs, or other structures including, for example, spaced-apart side supports that require an apparatus or system such as that described herein).

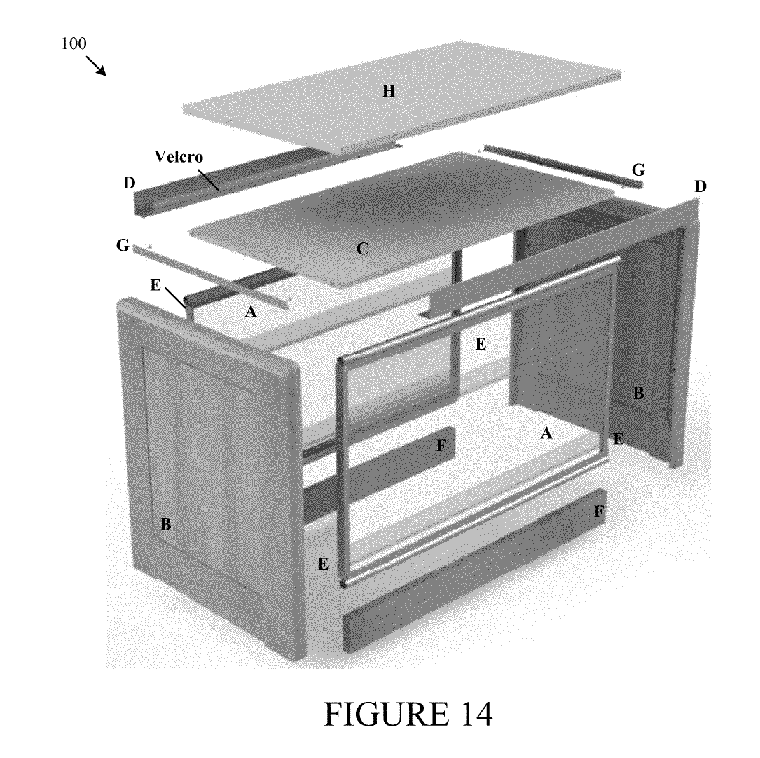

FIG. 14 is an exploded assembly view of the crib. Preferably, the crib 100 ships with fully assembled front and back panel frames A, full assembled side panels B, a mattress support panel C, mattress support rails D and G, side mounting extrusions E, back base rails F and a mattress H. During assembly, a user attaches the front and back panels A to side wood panels B using bolts, and lock washers through side mounting extrusions E to threated inserts in side wood panels (A to E to B). Then, the user attaches front and back base rails F to side wood panels B using a hidden K/D fastener solution such as Minifix and Cam (F to B). The user inserts the mattress support panel sub assembly (D plus D) on to the mattress side support rails G previously installed by manufacturer and top with mattress H.

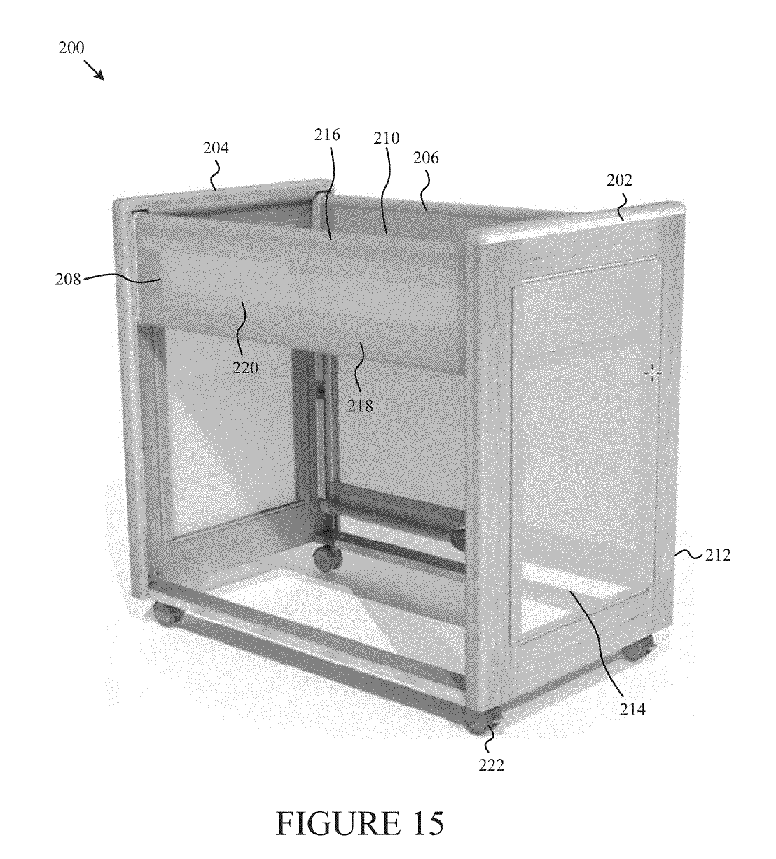

FIG. 15 illustrates a second embodiment of a crib 200. The crib 200 includes a first side 202, second 204, third side 206 and fourth side 208. Preferably, the third side 206 and fourth side 208 are wider than the first side 202 and second side 204, such that the four sides 202, 204, 206, 208 define a generally rectangular interior space 210. As illustrated in FIG. 15, the first side 202 includes a solid perimeter construction 212 with a breathable material 214 there between for aesthetic reasons, structural support and to prevent entrapment of the infants' limbs. Of course, one of ordinary skill in the art would recognize that alternative designs are also possible. Likewise, the second side 204 has similar construction.

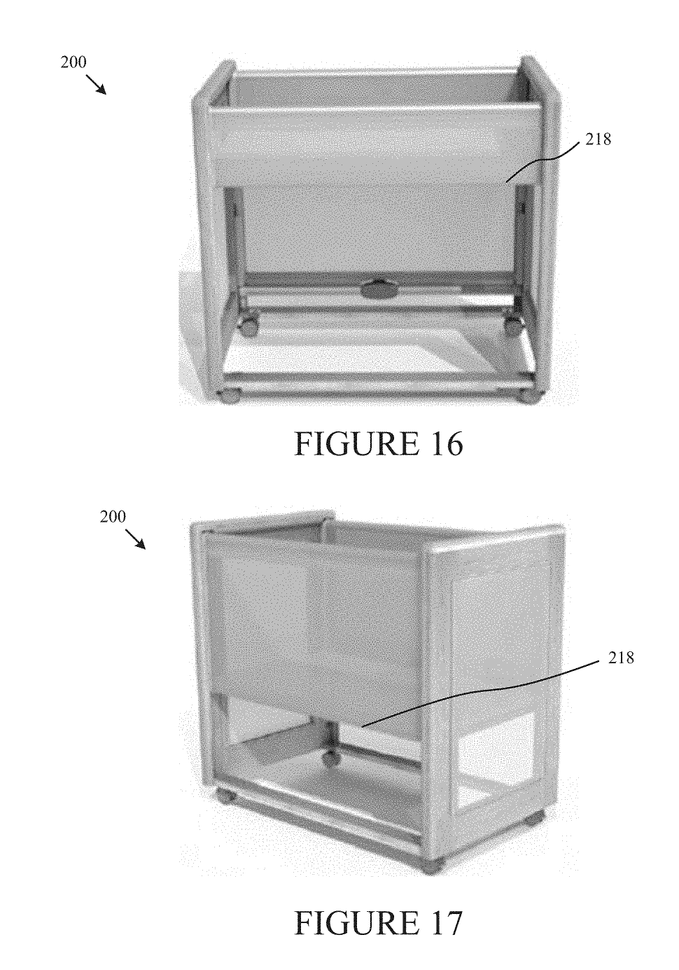

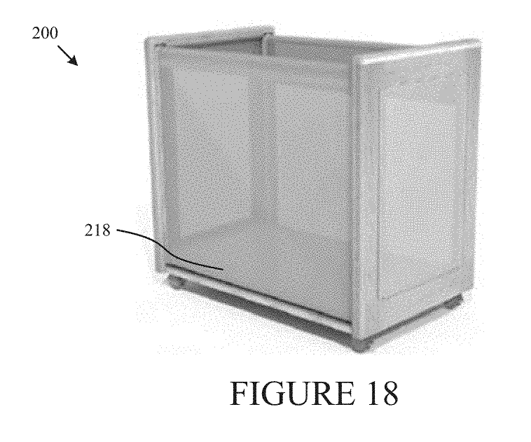

Preferably, the fourth side 208 includes a top support member 216 and a bottom support member 218. The top support member 216 is fixed to the first side 202 and second side 204 such that it is not movable. The bottom support member 218 is movably attached between the first side 202 and second side 204 such that the bottom support member 218 can move between different positions with respect to the top support member 216. As illustrated in FIG. 16, the bottom support member 218 is in a first position similar to a bassinet position. As illustrated in FIG. 17, the bottom support member 218 is a second position similar to a mini crib position. As illustrated in FIG. 18, the bottom support member 218 is in a third even lower position. The top support member 216 and the bottom support member 218 are wrapped by a breathable material 220. The breathable material 220 is securely attached around the top support member 216 on one side of the crib and loosely attached about the top support member 216 on another side of the crib and moveably secured around the bottom support member 218, such that when the bottom support member 218 is moved the breathable material 220 also moves in ensure the entire interior of the crib 200 is wrapped in a breathable material 220 to keep the infant safe.

The breathable material 220 can be any material that allows air to flow through it, including a mesh like material. The breathable material 220 also allows the crib sides to be see through to see the infant inside. The third side 206 also has s similar construction to the fourth side 208. The crib 200 further includes rollers or casters 222 that support the crib 200. The rollers or casters 222 allow the crib to be more easily moved about. One of ordinary skill in the art would also recognize that other supports such as leg designs are possible.

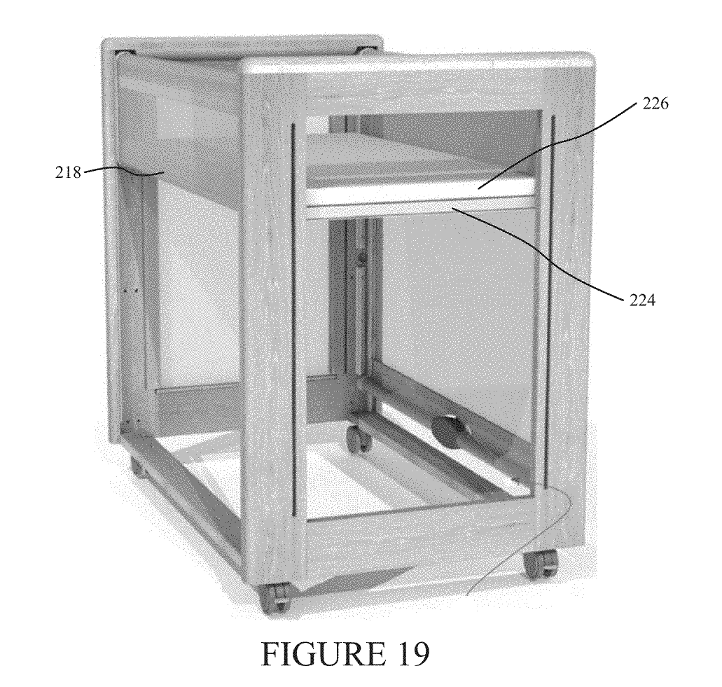

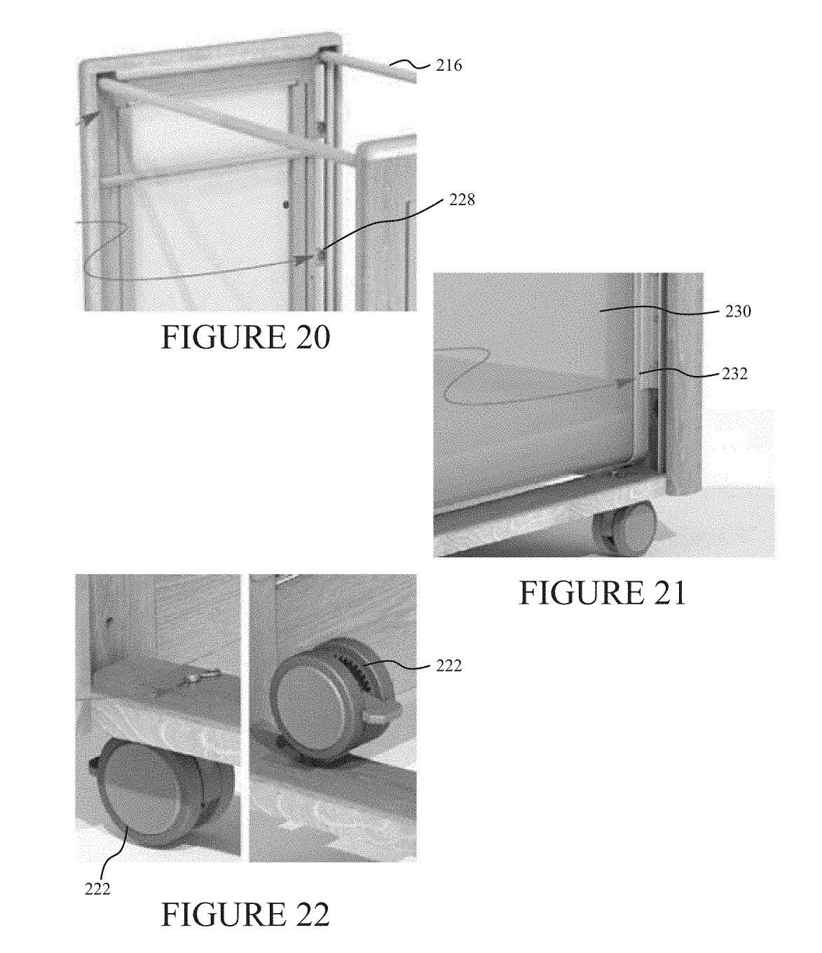

FIG. 19 further illustrates crib 200. The crib 200 also includes a mattress platform 224 and a mattress 226 that moves up and down as the bottom support member 218 is moved up and down. FIG. 20 illustrates the top support member 216 and illustrates a hole position 228 that can retain the bottom support member 218 in a first position. FIG. 21 illustrates a gap between a mesh sling 230, described in more detail below, and the third and fourth sides 206, 208 restrained by a Velcro restraint strip. 232. FIG. 22 is a blow up of the caster or roller 222. The caster or roller is retained under the crib 200 by a cotter pin 234. The cotter pin 234 can be removed by the user and the roller 222 can be removed to enable the crib 200 to more securely stand on the floor. The roller 222 can be reinstalled above the bottom of the crib in reverse to store the roller 222.

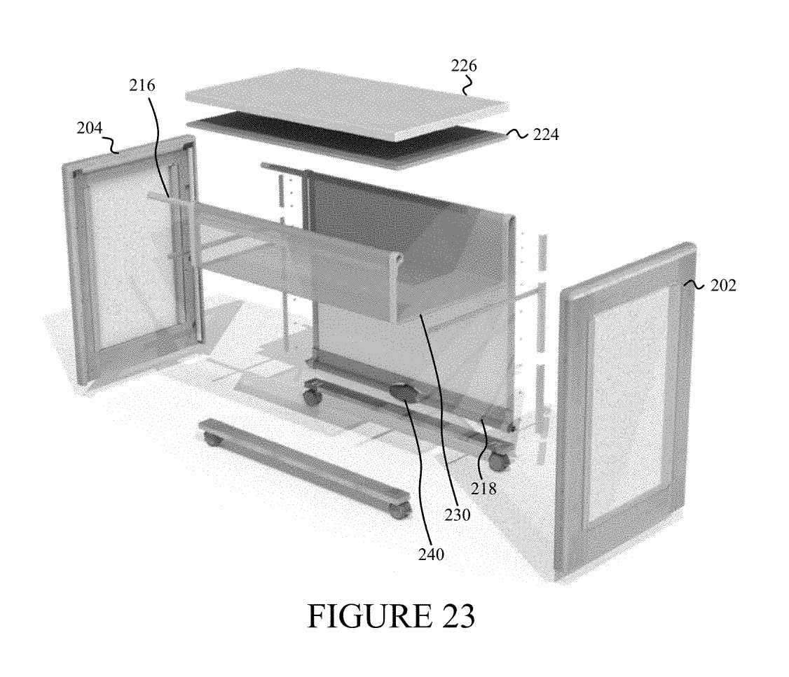

FIG. 23 is a blow up diagram of the crib 200 that illustrates the workings of the mesh sling 230. In general the mesh sling 230 is designed to allow the mesh to move up and down as the bottom support member 218 is moved up and down such that the mesh encloses the interior of the crib 200 in any position as shown in FIGS. 16-18. The mesh will slide about the bottom support members 218 to create a mesh sling for retention of the mattress support 224 and mattress 226. A double action locking handle is used to facilitate movement of the mesh sling to the various positions.

In many embodiments, the crib is configured to provide breathable material throughout the crib such that the head of an infant lying in the crib is exposed to mainly breathable material. The breathable material may include any suitable material that provides breathable functionality such as a mesh type material. Breathable functionality refers to the ability of the material to allow air to move effectively there through. As used herein, when air is indicated as moving effectively through a material, it is meant that the material includes openings (e.g., mesh openings, open-framework, spaces between elements thereof, or even those that may not be visually perceivable openings but still allow a breathable function to occur) that do not impede air movement to an extent that would prevent a human being from breathing through (e.g., when a human's respiratory openings (e.g., nose/mouth) are in direct contact with a material) such a material in order to help prevent suffocation and further that such openings are too small to permit an infant to insert a finger or toe there through. For example, such materials may include cotton, silk, polyester, nylon, modal/semi-cellulose based fabrics, etc.

In one embodiment, the mesh-type material may include a mesh available from Apex Mills, Inc. under the trade designation TA1 Mesh. However, other various similar mesh materials (e.g., mesh material having suitable openings) are available. A Suffocation Hazard Assessment was performed by RAM Consulting (Oak Brook, Ill.) (e.g., the Assessment is further described herein and for which protocol is available from RAM Consulting) on the TAI Mesh resulting in average readings of 1.6 cm H₂O and, for an upper specification limit of 5 cm H₂O, a Z-value of 9.0 was obtained.

In one example embodiment, the breathable material is a breathable padded mesh-type material (e.g., a padded spacer mesh). Of course, other breathable materials can be used including a single layer mesh. The meshes or other fabrics shown may include designs on the mesh. The meshes or other fabrics may also include a variety of mesh designs and types. It will be recognized that the thickness of the padded mesh material may vary, as well as for other materials described herein. For example, more padding may create a softer more plush effect with slightly different breathability/ventilation properties and more opaqueness (e.g., less light transmissive) whereas less padding may create more breathability and buoyancy with less opaqueness (e.g., more light transmissive). Preferably, the panels described herein are at least somewhat transparent such that at least motion of the child in the crib can be seen.

The breathable material may be a woven polymeric fiber mesh material that is integrated with or attached to a front and/or back substructure. The front substructure may include larger openings on the front substructure than on the back substructure. In one example embodiment, the padded mesh material may be integrated with or attached to the front and back substructures by weaving the fibers that are provided as part of the pile substructure through the front and back substructure. In another embodiment, the breathable material may be integrated by sewing, or otherwise attaching, the padded mesh material between a front and back substructure or other substructures. That is, in this embodiment the padded mesh material is integrated by attaching to other materials, such as breathable materials or pad materials, to form a multi-layer structure. The multi-layer structure may be, for example, laminated or quilted.

In one embodiment, for example, the breathable padded mesh material may include a padded spacer mesh available from Apex Mills, Inc. under the trade designation DNB27 Spacer Mesh. However, other various similar padded spacer mesh materials are available.

In another embodiment, the mesh-type material is a breathable padded mesh material in combination with one or more other material layers. For example, the breathable padded mesh material may be used in combination with one or more layers of other material adjacent to (e.g., one material laid flat against the other) either the front substructure and/or back substructure of the breathable padded mesh material. In various embodiments of such a combination, one or more layers of material may be used adjacent the front substructure, one or more layers of material may be used adjacent the back substructure, or one or more layers of material may be used adjacent the front substructure and the back substructure. For example, such additional layers may be layers of cotton material, knit jersey material, etc. Such additional material layers may provide additional benefits such as, for example, thermal properties with breathability.

Further, for example, the breathable material when used alone, or in combination with one or more additional layers, may be a breathable material (e.g., a breathable padded mesh material, such as a spacer mesh) that has a suffocation resistance level of less than about 15 cm H.sub.2O, and preferably less than about 5 cm H₂O. Such a suffocation resistance is determined according to the RAM Consulting Virtual Child Suffocation Hazard Assessment Model which is a physical model and testing methodology that quantitatively assesses the potential suffocation hazards posed by various types of materials. The details of this Model are available from RAM Consulting (Oak Brook, Ill.). Further, according to this Model, Z-values are determined that are statistical measurement tools that describe and predict product performance in relation to its specification limit (e.g., such as those described below). For example, the suffocation resistance limit of 5 cm H.sub.2O is an upper specification limit for materials or products that foreseeably are used and/or intended for young infants with high accessibility; and further, the suffocation resistance limit of about 15 cm H₂O is an upper specification limit for other materials or products (e.g., those for toddlers). A Z-value of 4.0 or greater with the corresponding upper specification limit for each applicable testing technique is required for a product to be classified as a very low suffocation risk. The details regarding the determination of Z-values are available from RAM Consulting (Oak Brook, Ill.).

Suffocation Hazard Assessment was performed by RAM Consulting (Oak Brook, Ill.) on various configurations using the breathable padded mesh material available from Apex Mills, Inc. under the trade designation DNB27 Spacer Mesh.

1 Configuration 1: Single Layer of Padded Spacer Mesh Configuration 2: Layer 1: Padded Spacer Mesh Layer 2: Cotton Configuration 3: Layer 1: Knit Jersey Layer 2: Padded Spacer Mesh Layer 3: Cotton Configuration 4: Layer 1: Cotton Layer 2: Padded Spacer Mesh Layer 3: Cotton Configuration 5: Layer 1: Knit Jersey Layer 2: Padded Spacer Mesh Layer 3: Knit Jersey Configuration 6: Layer 1: Padded Spacer Mesh Layer 2: Flannel Fabrics tested: Knit Jersey Manufacturer: NATEX Content: 50% Polyester/50% Cotton Knit Jersey Style#: INT Cotton Manufacturer: SOUTHERN BELLE Content: 100% Cotton Style#: L93N67 Flannel Manufacturer: QUILTERS CORNER Content: 100% Cotton Style#: RN41324.

A screening was performed on all configurations in both a dry and wet state. The spacer padded mesh when layered with fabrics resulted in a satisfactory reading based on values in cm H₂O, wherein the specification upper limit for products young children are intended to lie on is equal to 5 cm H₂O (e.g., mattress pads or items young infants are intended to have their face on) and wherein the specification for products young children are not intended to lie on is equal to 15 cm H₂O.

Four individual readings were performed with an average being determined. Dry state readings did not register, thus presenting very low hazard when the configurations were dry (i.e., under the 5 cm H₂O specification limit). In the wet state (after application of 8 ml of sprayed on water), the average readings for the configurations were between 4.6 cm H₂O and 6.2 cm H₂O.

For the individual single layer of spacer padded mesh, average readings of 1.7 cm H₂O were taken. Further, for an upper specification limit of 5 cm H₂O, a Z-value of 9.5 was obtained.

The air permeability of breathable materials may allow the breathable material to be layered with other breathable material to create a layered breathable material, while still maintaining air permeability (CFM).

Testing was conducted by Bureau Veritas in accordance with ASTM D737 standards to determine the air permeability (CFM) of a single layer of textile materials. Additionally, various combinations of layered materials were also tested to determine air permeability. For example, a single layer of breathable material with a thickness of 0.13 inches provided an air permeability of 1013.1 CFM. Adjusting the properties (e.g., thickness, weave pattern, etc.) of the single layer of a breathable material may allow the air permeability to achieve an air permeability of at least 1250 CFM. Adjusting the properties (e.g., thickness, weave pattern, etc.) of the layered breathable material may allow the air permeability to achieve an air permeability of at least 900 CFM.

The breathable materials allow for air circulation. When a padded, soft breathable mesh material is utilized, further protection is provided to a child from bodily harm. When using one or more of the breathable mesh materials described herein, it is preferred that little rebreathing of carbon dioxide occur when a child's face is in direct contact with the material.

One skilled in the art will recognize that various types of padding may be used in addition to the breathable material in order to form one or more of the shapes of the objects previously described herein. Further, for example, such padding materials may be the breathable padded mesh material itself and/or other breathable materials, such as cotton, jersey, flannel, polyester, nylon, rayon, gabardine, terry cloth, etc.

The preceding described embodiments are illustrative of the practice of the invention. It is to be understood, therefore, that other expedients known to those skilled in the art or disclosed herein may be employed without departing from the invention or the scope of the appended claims. For example, various apparatus or steps of one embodiment described herein may be used with one or more other embodiments described herein to form various combinations of methods, systems, or apparatus contemplated by the present invention. As such, the present invention includes within its scope other methods, systems and apparatus for implementing and using the invention described herein.

What is claimed is:

1. A crib comprising:
a first and second side that each include a first perimeter support having a bottom support portion, a first breathable material retained by the perimeter support, and a lateral support member that further supports the breathable material in a position within the perimeter support and attached to the perimeter support;
third and fourth sides; wherein the first, second, third and fourth sides define an interior;
a mattress support platform positioned in the interior and movable between a first position proximate the lateral support member and a second, lower position proximate the bottom portion of the perimeter support; and
wherein the breathable material has an air permeability of between 385 CFM to 1530 CFM and a light permeability of between 47 and 99%.

2. The crib liner of claim 1, wherein the breathable material has a mesh coverage of between 32% and 91%.

3. The crib liner of claim 2, wherein the breathable material has an ultraviolet radiation of between 47% and 100%.

4. A crib comprising:
first and second sides;
third and fourth sides that each include a top support fixedly attached to the first and second sides and a bottom support movably attached to the first and second sides, a first breathable material retained by the top support and the bottom support and the breathable material forming a sling for retention of a mattress support platform; and
wherein the mattress support platform is movable to various positions by moving the bottom support member and wherein the sling also moves such that the breathable material moves up and down to enclose the space above the mattress support platform.
